(19) United States
(12) Patent Application Publication
(10) Pub. No.: US 2026/0246940 A1
(43) Pub. Date: Aug. 20, 2026

(54) CONTEXT ADAPAPTIVE BINARY ARITHMETIC CODING INITIALIZATION FOR GRADUAL DECODER REFRESH PICTURES

(71) Applicant: Nokia Technologies Oy, Espoo (FI)

(72) Inventors: Seungwook HONG, San Diego (CA); Limin WANG, San Diego, CA (US); Krit PANUSOPONE, San Diego, CA (US)

(21) Appl. No.: 19/165,429

(22) PCT Filed: Feb. 22, 2024
(86) PCT No.: PCT/EP2024/054478

§ 371 Date: Sep. 15, 2025

Related U.S. Application Data
(60) Provisional application No. 63/493,294, filed on Mar. 30, 2023.

(51) Int. Cl. H04N 19/13; H04N 19/105; H04N 19/172; H04N 19/91

(52) U.S. Cl. CPC H04N 19/13; H04N 19/105; H04N 19/172; H04N 19/91

(57) ABSTRACT

In accordance with example embodiments of the invention there is at least a method and apparatus to perform identifying a gradual decoder refresh (GDR) picture within a gradual decoder refresh period of a sequence of pictures, wherein the gradual decoder refresh picture is a first picture within the gradual decoder refresh period of the sequence of pictures, and performing context-adaptive binary arithmetic coding initialization to determine at least one context-adaptive binary arithmetic coding state; and using the at least one context-adaptive binary arithmetic coding state for one of encoding or decoding the gradual decoder refresh picture, as may be seen in FIG. 6.

### TECHNICAL FIELD

The teachings in accordance with the exemplary embodiments of this invention relate generally to new Context-Adaptive Binary Arithmetic Coding initialization operations and, more specifically, relate to new Context-Adaptive Binary Arithmetic Coding initialization operations where after coding of GDR pictures, CABAC states of the coded GDR pictures may be stored and inherited by other inter pictures.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
CABAC context adaptive binary arithmetic coding
CRA clean random access
ECM enhanced compression module
GDR gradual decoder refresh
IDR instantaneous decoding refresh
IRAP intra random access point

CABAC (Context-Adaptive Binary Arithmetic Coding) is a form of entropy coding for data compression. CABAC engine maintains a set of context model tables representing the probability of a particular symbol occurring given the context of previously coded symbols, and updates the probability estimates in the context model tables after each symbol is coded. CABAC has been used in video coding standards, such as AVC (H.264)/HEVC (H.265)/VVC (H.266). In AVC/HEVC/VVC [1], CABAC initialization is invoked for each input picture, regardless of intra or inter picture.

Example embodiments of this invention provide improved operations for at least CABAC initialization.

### SUMMARY

This section contains examples of possible implementations and is not meant to be limiting.

In another example aspect of the invention, there is an apparatus, such as a communication network apparatus such as a UE or gNB or other network device, comprising: at least one processor; and at least one non-transitory memory storing instructions, that when executed by the at least one processor, cause the apparatus at least to: identify a gradual decoder refresh (GDR) picture within a gradual decoder refresh period of a sequence of pictures, wherein the gradual decoder refresh picture is a first picture within the gradual decoder refresh period of the sequence of pictures, and perform context-adaptive binary arithmetic coding initialization to determine at least one context-adaptive binary arithmetic coding state; and use the at least one context-adaptive binary arithmetic coding state for one of encoding or decoding the gradual decoder refresh picture.

In still another example aspect of the invention, there is a method, comprising: identifying a gradual decoder refresh (GDR) picture within a gradual decoder refresh period of a sequence of pictures, wherein the gradual decoder refresh picture is a first picture within the gradual decoder refresh period of the sequence of pictures, and performing context-adaptive binary arithmetic coding initialization to determine at least one context-adaptive binary arithmetic coding state; and using the at least one context-adaptive binary arithmetic coding state for one of encoding or decoding the gradual decoder refresh picture.

A further example embodiment is an apparatus and a method comprising the apparatus and the method of the previous paragraphs, wherein the gradual decoder refresh picture is an inter picture, wherein other pictures within a gradual decoder refresh period of the sequence of pictures comprise the gradual decoder refresh (GDR) picture and a plurality of associated recovering pictures, wherein a sequence level flag may indicate if inter pictures are allowed to inherit context-adaptive binary arithmetic coding states from previously coded inter pictures, wherein the context-adaptive binary arithmetic coding is coding for data compression, wherein based on the sequence level flag indication inter pictures can inherit context-adaptive binary arithmetic coding states from past coded inter pictures, wherein gradual decoder refresh pictures will not inherit context-adaptive binary arithmetic coding states from any past coded inter picture regardless of an indication from the sequence level flag indication, wherein the gradual decoder refresh pictures use initialized context-adaptive binary arithmetic coding states regardless of a sequence level flag, wherein after one of encoding or decoding the gradual decoder refresh picture, storing or updating at least one context-adaptive binary arithmetic coding state, wherein there is storing or updating at least one context-adaptive binary arithmetic coding state of the gradual decoder refresh picture, wherein the storing or updating the at least one context-adaptive binary arithmetic coding state is performed after the coding of the gradual decoder refresh picture, wherein the gradual decoder refresh picture is of at least one of a type B picture or type P picture, wherein a separate context-adaptive binary arithmetic coding states table is maintained for each inter type B picture type or inter type P picture, wherein the sequence of pictures comprises at least one of a gradual decoder refresh picture, a recovering picture, or an intra random access point picture, wherein each of the at least one entry of the separate context-adaptive binary arithmetic coding states table is associated with a unique pair of a temporal identification and a quantization parameter, wherein the separate context-adaptive binary arithmetic coding states table comprises at least one entry, wherein a separate context-adaptive binary arithmetic coding states table state is maintained for each picture of the more than one picture, wherein each of the at least one state entry is associated with a unique pair of a temporal identification and a quantization parameter, wherein the at least one entry is sorted first by the temporal identification and then by the quantization parameter, wherein, after an inter picture with a temporal identification and a quantization parameter is coded, if no entry with same temporal identification and same quantization parameter is found in the context-adaptive binary arithmetic coding states table, CABAC states of the coded inter picture then replace a first entry of the context-adaptive binary arithmetic coding states table, wherein entries in the context-adaptive binary arithmetic coding states table are then sorted by temporal identification and quantization parameter, wherein if no state entry with a same temporal identification and a quantization parameter is found in the context-adaptive binary arithmetic coding states table, the at least one state entry then replace a first state entry sorted with a temporal identification and quantization parameter of the context-adaptive binary arithmetic coding states table, wherein the at least one state entry is sorted in the context-adaptive binary arithmetic coding states table according to equations: Tid(m)≤Tid(m+1), m=0, 1, . . . and then by Qp(m)≤Qp(m+1), m=0, 1, . . . where Tid is a temporal identification and Qp is a quantization parameter and m is an integer representing a number of state entries, wherein there is based on the coding perform enhanced compression using an enhanced compression module on the more than one picture picture, wherein the coding is one of encoding or decoding the more than one picture, wherein based on encoding starting at the gradual decoder refresh inter picture a gradual decoder refresh inter picture inherits context-adaptive binary arithmetic coding states from previously coded inter pictures, wherein encoding and decoding are synced to produce a same reconstructed intra random access point picture to be used as reference for the at least one picture following the gradual decoder refresh picture.

A non-transitory computer-readable medium storing program code, the program code executed by at least one processor to perform at least the method as described in the paragraphs above.

In yet another example aspect of the invention, there is an apparatus comprising: means for identifying a gradual decoder refresh picture of a sequence of pictures during a gradual decoder refresh period, wherein the gradual decoder refresh picture is a first picture within the gradual decoder refresh period of the sequence of pictures, and means for performing context-adaptive binary arithmetic coding initialization to determine at least one context-adaptive binary arithmetic coding state; and means for using the at least one context-adaptive binary arithmetic coding state for one of encoding or decoding the gradual decoder refresh picture.

In accordance with the example embodiments as described in the paragraph above, at least the means for coding, invoking, and using comprises a network interface, and computer program code stored on a computer-readable medium and executed by at least one processor.

A communication system comprising the network side apparatus and the user equipment side apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows a CABAC initialization is invoked for each picture regardless of intra or inter picture;

FIG. 2 shows that inter pictures are allowed to inherit CABAC states from previously coded inter pictures;

FIG. 3 CABAC initialization still needs to be performed for GDR pictures;

FIG. 4 shows CABAC states table of M entries;

FIG. 5 shows a high level block diagram of various devices used in carrying out various aspects of the invention; and

FIG. 6 shows a method in accordance with example embodiments of the invention which may be performed by an apparatus.

### DETAILED DESCRIPTION

In example embodiments of this invention there is proposed at least a method and apparatus for new Context-Adaptive Binary Arithmetic Coding initialization operations for GDR pictures, where after coding of GDR pictures, CABAC states of the coded GDR pictures may be stored and inherited by other inter pictures.

As similarly stated above, the CABAC engine maintains a set of context model tables representing the probability of a particular symbol occurring given the context of previously coded symbols, and updates the probability estimates in the context model tables after each symbol is coded. CABAC initialization is invoked for each input picture, regardless of intra or inter picture.

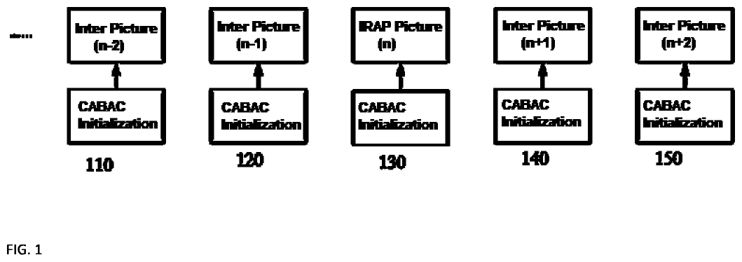

FIG. 1 shows an example in low-delay configuration, where the picture output order is the same as the picture coding order.

As shown in step 110 of FIG. 1 the CABAC initialization is invoked for an Inter Picture (n−2). As shown in step 120 of FIG. 1 the CABAC initialization is invoked for an Inter Picture (n−1). As shown in step 130 of FIG. 1 the CABAC initialization is invoked for an IRAP Picture (n). Also as shown in step 140 of FIG. 1 the CABAC initialization is invoked for an Inter Picture (n+1). Then as shown in step 150 of FIG. 1 the CABAC initialization is invoked for an Inter Picture (n+2).

As shown in FIG. 1 the initialization process typically involves setting the initial probability estimates for each symbol in each context model table, the initial values of some parameters using in probability adaptation, the initial arithmetic coding range, etc. From CABAC perspective, parsing of coded pictures can be performed independently.

Intra pictures are standalone pictures that are decoded without relying on any other pictures. In VVC, IRAP (Intra Random Access Point) pictures are intra coded pictures, which includes CRA (Clean Random Access) pictures and IDR (Instantaneous Decoding Refresh) pictures.

Inter picture is a picture that use inter prediction in its decoding process. For example in FIG. 1, inter picture (n+2) may temporally refer to IRAP picture (n) and inter picture (n+1). Inter picture can be B picture or P picture. In B pictures, an inter CU can refer to two reference lists and in P picture, an inter CU can only refer to one reference list. A reference list is a list of previously coded pictures that are used as references for the future pictures.

ECM (Enhanced Compression Model) is a potential new video coding standard, currently under development sponsored by JVET. ECM allows inter pictures to inherit CABAC states from previously coded inter pictures. This, however, can cause problems for GDR applications.

An example embodiment of this invention provides for CABAC initialization to be invoked for GDR pictures.

ECM (Enhanced Compression Model) is a potential new video coding standard, currently under development sponsored by JVET. In ECM, CABAC is also used to compress the coding information, such as coding modes, motion information, changes in quantization parameter, residuals, etc.

In order to improve the coding performance, ECM allows an inter picture to inherit CABAC states from previously coded inter picture with the same picture type, temporal ID and quantization parameter. Hence, in ECM, CABAC states of inter coded pictures may be stored in CABAC states table and inherited by subsequently coded inter pictures.

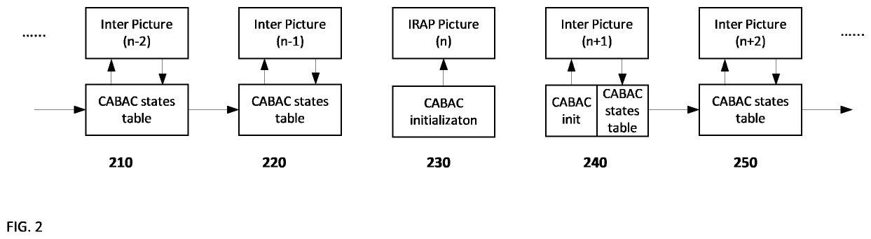

FIG. 2 shows an example in low-delay configuration.

As shown in step 210 of FIG. 2, the Inter Picture (n−2) uses the CABAC states inherited from previously coded inter picture, and after the Inter Picture (n−2) is coded, its CABAC states are stored. As shown in step 220 of FIG. 2, the Inter Picture (n−1) uses the CABAC states inherited from the Inter Picture (n−1), and after the Inter Picture (n−1) is coded, its CABAC states are stored. As can be seen in FIG. 2, steps 210 and 220 are in conjunction. As shown in step 230 of FIG. 2, the CABAC initialization is invoked for an IRAP Picture (n). As shown in step 240 of FIG. 2, the CABAC initialization is invoked for the Inter Picture (n+1), and after the Inter Picture (n+1) is coded, its CABAC states are stored. As shown in step 250 of FIG. 2, the Inter Picture (n+2) uses the CABAC states inherited from the Inter Picture (n+1), and after the Inter Picture (n+1) is coded, its CABAC states are stored for future inter picture. As can be seen in FIG. 2 steps 240 and 250 are in conjunction.

It is noted that, as can be seen from FIG. 2 ECM still invokes CABAC initialization for IRAP pictures, including cleaning up CABAC states table and resetting the initial probability estimates for each symbol in each model table, the initial values of some parameters using in probability adaptation, the initial arithmetic coding range, etc.

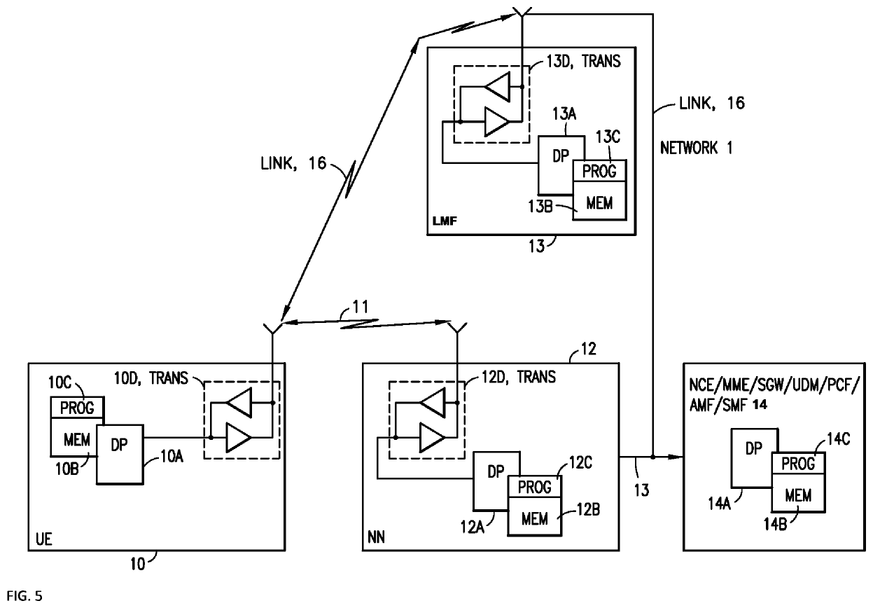

Before describing the example embodiments as disclosed herein in detail, reference is made to FIG. 5 for illustrating a simplified block diagram of various electronic devices that are suitable for use in practicing the example embodiments of this invention.

FIG. 5 shows a block diagram of one possible and non-limiting exemplary system in which the example embodiments may be practiced. In FIG. 5, a user equipment (UE) 10 is in wireless communication with a wireless network 1 or network, 1 as in FIG. 5. The wireless network 1 or network 1 as in FIG. 5 can comprise a communication network such as a mobile network e.g., the mobile network 1 or first mobile network as disclosed herein. Any reference herein to a wireless network 1 as in FIG. 5 can be seen as a reference to any wireless network as disclosed herein. Further, the wireless network 1 as in FIG. 5 can also comprises hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded or vehicle-mounted mobile device and performs a language signaling and/or data exchange with the RAN.

The UE 10 includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to NN 12. The one or more memories MEM 10B include computer program code PROG 10C. The UE 10 communicates with NN 12 via a wireless link 11 or 16.

The NN 12 (NR/5G Node B, an evolved NB, or LTE device) is a network node such as a master or secondary node base station (e.g., for NR or LTE long term evolution) that communicates with devices such as UE 10 of FIG. 5. The NN 12 provides access to wireless devices such as the UE 10 to the wireless network 1. The NN 12 includes one or more processors DP 12A, one or more memories MEM 12B, and one or more transceivers TRANS 12D interconnected through one or more buses. In accordance with the example embodiments these TRANS 12D can include X2 and/or Xn interfaces for use to perform the example embodiments. Each of the one or more transceivers TRANS 12D includes a receiver and a transmitter. The one or more transceivers TRANS 12D can be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB such as via link 16. Further, the link 11, link 16 and/or any other link may be wired or wireless or both and may implement, e.g., an X2 or Xn interface. Further the link 11 and/or link 16 may be through other network devices such as, but not limited to an NCE/MME/SGW/UDM/PCF/AMF/SMF 14 device as in FIG. 5. The NN 12 may perform functionalities of an MME (Mobility Management Entity) or SGW (Serving Gateway), such as a User Plane Functionality, and/or an Access Management functionality for LTE and similar functionality for 5G.

The LMF 13 (a NR/5G, evolved NB, or LTE device) is a network device such as a device including a location management function device (e.g., for NR or LTE long term evolution) that communicates with devices such the NN 12 and UE 10 of FIG. 5. The LMF 13 can be associated with a mobility function device such as an AMF or SMF, further the LMF 13 may communicate with devices such as the NN 12 and/or UE 10 and/or the wireless network 1. The LMF 13 includes one or more processors DP 13A, one or more memories MEM 13B, one or more network interfaces, and one or more transceivers TRANS 13D interconnected through one or more buses. In accordance with the example embodiments these network interfaces of LMF 13 can include X2 and/or Xn interfaces for use to perform the example embodiments. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the LMF 13 to perform one or more of the operations as described herein. The LMF 13 may communicate with another mobility function device and/or eNB such as the NN 12 and the UE 10 or any other device or the NCE/MME/SGW/UDM/PCF/AMF/SMF 14 using, e.g., link 11 or link 16 or another link. The Link 16 as shown in FIG. 5 can be used for communication between the NN12 and the NN13. These links maybe wired or wireless or both and may implement, e.g., an X2 or Xn interface. Further, as stated above the link 11 and/or link 16 may be through other network devices such as, but not limited to an NCE/MME/SGW device such as the NCE/MME/SGW/UDM/PCF/AMF/SMF 14 of FIG. 5.

The NCE/MME/SGW/UDM/PCF/AMF/SMF 14 device is a network device that provides NCE/MME/SGW/UDM/PCF/AMF and/or SMF services (e.g., for NR or LTE long term evolution) and that communicates with devices such the LMF 13, NN 12, and UE 10 of FIG. 5. The NCE/MME/SGW/UDM/PCF/AMF/SMF 14 can be associated with a mobility function device such as an AMF or SMF, further the NCE/MME/SGW/UDM/PCF/AMF/SMF 14 may communicate with devices such as the NN 12 and/or UE 10 and/or the wireless network 1. The NCE/MME/SGW/UDM/PCF/AMF/SMF 14 includes one or more processors DP 14A, one or more memories MEM 14B, one or more network interfaces, and one or more transceivers TRANS 14D interconnected through one or more buses. In accordance with the example embodiments these network interfaces of NCE/MME/SGW/UDM/PCF/AMF/SMF 14 can include X2 and/or Xn interfaces for use to perform the example embodiments. Each of the one or more transceivers TRANS 14D includes a receiver and a transmitter that can optionally be connected to one or more antennas. The one or more memories MEM 14B include computer program code PROG 14C. For instance, the one or more memories MEM 14B and the computer program code PROG 14C are configured to cause, with the one or more processors DP 14A, the NCE/MME/SGW/UDM/PCF/AMF/SMF 14 to perform one or more of the operations as described herein. The NCE/MME/SGW/UDM/PCF/AMF/SMF 14 may communicate with another mobility function device and/or eNB such as the NN 12 and the UE 10 or any other device or the NCE/MME/SGW/UDM/PCF/AMF/SMF 14 using, e.g., link 11 or link 16 or another link. The Link 16 as shown in FIG. 5 can be used for communication between the NN12 and the NN13. These links maybe wired or wireless or both and may implement, e.g., an X2 or Xn interface. Further, at least the link 16 may be through other network devices such as, but not limited to the UE 10, the NN 12, and/or the LMF 13 of FIG. 5.

The one or more buses of the device of FIG. 5 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and these devices can include one or more buses that could be implemented in part as fiber optic cable to connect the other elements of the NN 12 to a RRH.

It is noted that although FIG. 5 shows a network node such as NN 12, this node can incorporate or be incorporated into an eNodeB or eNB or gNB such as for LTE and NR, and would still be configurable to perform example embodiments.

Also it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB.

The wireless network 1 or any network it can represent may or may not include a NCE/MME/SGW/UDM/PCF/AMF/SMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management Function (AMF) functionality, and/or Session Management (SMF) functionality, and/or Location Management Function (LMF), and/or Authentication Server (AUSF) functionality and which provides connectivity with a further network, such as a telephone network and/or a data communications network (e.g., the Internet), and which is configured to perform any 5G and/or NR operations in addition to or instead of other standard operations at the time of this application. The NCE/MME/SGW/UDM/PCF/AMF/SMF 14 is configurable to perform operations in accordance with example embodiments in any of an LTE, NR, 5G and/or any standards based communication technologies being performed or discussed at the time of this application. In addition, it is noted that the operations in accordance with example embodiments, as performed by the NN 12 and/or LMF 13, may also be performed at the NCE/MME/SGW/UDM/PCF/AMF/SMF 14.

The NCE/MME/SGW/UDM/PCF/AMF/SMF 14 includes one or more processors DP 14A, one or more memories MEM 14B, and one or more network interfaces (N/W I/F(s)), interconnected through one or more buses coupled with the link 13 and/or link 16. In accordance with the example embodiments these network interfaces can include X2 and/or Xn interfaces for use to perform the example embodiments. The one or more memories MEM 14B include computer program code PROG 14C. The one or more memories MEM14B and the computer program code PROG 14C are configured to, with the one or more processors DP 14A, cause the NCE/MME/SGW/UDM/PCF/AMF/SMF 14 to perform one or more operations which may be needed to support the operations in accordance with the example embodiments.

It is noted that that the NN 12 and/or LMF 13 and/or UE 10 can be configured (e.g. based on standards implementations etc.) to perform functionality of a Location Management Function (LMF). The LMF functionality may be embodied in any of these network devices or other devices associated with these devices. In addition, functions of an LMF such as the LMF 13 can be co-located with UE 10 such as to be separate from the NN 12 and/or LMF 13 of FIG. 5 for performing operations in accordance with example embodiments as disclosed herein.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, and/or DP14A and memories MEM 10B, MEM 12B, MEM 13B, and/or MEM 14B, and also such virtualized entities create technical effects.

The computer readable memories MEM 10B, MEM 12B, MEM 13B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 10B, MEM 12B, MEM 13B, and MEM 14B may be means for performing storage functions. The processors DP10, DP12A, DP13A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, and DP14A may be means for performing functions, such as controlling the UE 10, NN 12, LMF 13, and other functions as described herein.

In general, various embodiments of any of these devices can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Further, the various embodiments of any of these devices can be used with a UE vehicle, a High Altitude Platform Station, or any other such type node associated with a terrestrial network or any drone type radio or a radio in aircraft or other airborne vehicle or a vessel that travels on water such as a boat.

As similarly stated above, example embodiments of the invention provide that CABAC initialization is invoked for GDR pictures.

ECM allows an inter picture to inherit CABAC states from previously coded inter picture with the same picture type, temporal ID and quantization parameter.

In ECM, CABAC states of inter coded pictures may be stored in CABAC states table and inherited by subsequently coded inter pictures.

In ECM, decoding can start at an IRAP picture or a GDR picture.

Assume decoding starts at an IRAP picture. Since CABAC initialization is invoked for the IRAP picture at both encoder and decoder, encoder and decoder are sync and they can produce the same reconstructed IRAP picture that will be used as reference for future pictures.

GDR pictures and recovering pictures [3-6] are inter pictures and they can be a type of either B picture or P picture. According to the current ECM design, a current inter picture may inherit the CABAC states of the previously coded inter picture with the same picture type/temporal ID/quantization parameter. There is a sequence level control flag specifying if such inheriting of CABAC states is allowed or not for all the inter pictures within a sequence.

Hence, if the sequence level control flag indicates inter pictures are allowed to inherit CABAC states from the previously coded inter pictures, at encoder, GDR pictures, as inter pictures, will inherit CABAC states from previously coded inter pictures.

Assume decoding starts at a GDR picture. Decoder has no prior-knowledge about the history involving in coding of the GDR picture. That is, at decoder, CABAC states table may be empty or CABAC states inherited by the GDR picture at encoder may not be available. Encoder and decoder, therefore, may not be sync and they may not produce the same refreshed areas in the reconstructed GDR picture that will be used as reference for subsequently coded inter pictures (e.g. the associated recovering pictures), which will result in leaks or mismatch at the recovery point picture.

To solve the above problem, it is proposed that GDR pictures shall not inherit CABAC states from previously coded inter pictures, even if the sequence level control flag indicates inter pictures are allowed to inherit CABAC states from previously coded inter pictures. Specifically, before coding of GDR pictures, CABAC states table shall be cleaned up and CABAC initialization shall be invoked at both encoder and decoder. After coding of GDR pictures, CABAC states of the coded GDR pictures may be stored and inherited by other inter pictures, except GDR pictures.

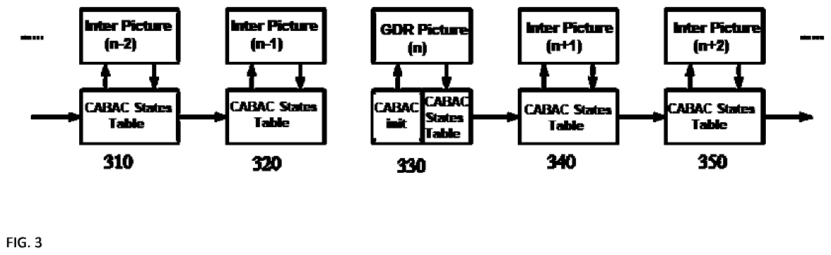

FIG. 3 illustrates the basic idea of the invention in low-delay configuration, where before coding of GDR picture (n), CABAC initialization is invoked and after coding of GDR picture (n), CABAC states of the GDR picture (n) are stored and may be inherited by the following inter pictures.

As shown in step 310 of FIG. 3, the Inter Picture (n−2) uses the CABAC states inherited from previously coded inter picture, and after the Inter Picture (n−2) is coded, its CABAC states are stored. As shown in step 320 of FIG. 3, the Inter Picture (n−1) uses the CABAC states inherited from the Inter Picture (n−2), and after the Inter Picture (n−1) is coded, its CABAC states are stored. As can be seen in FIG. 2 steps 310 and 320 are in conjunction. As shown in step 330 of FIG. 3, the CABAC initialization is invoked for the GDR Picture (n) (it is also an inter picture), and after the GDR Picture (n) is coded, its CABAC states are stored. Then as shown in step 340 of FIG. 3, the Inter Picture (n+1) uses the CABAC states inherited from the GDR Picture (n) and after the Inter Picture (n+1) is coded, its CABAC states are stored. As shown in step 350 of FIG. 3, the Inter Picture (n+2) uses the CABAC states inherited from the Inter Picture (n+1), and after the Inter Picture (n+2) is coded, its CABAC states are stored for future inter pictures. As can be seen in FIG. 2 steps 330, 340, and 350 are in conjunction.

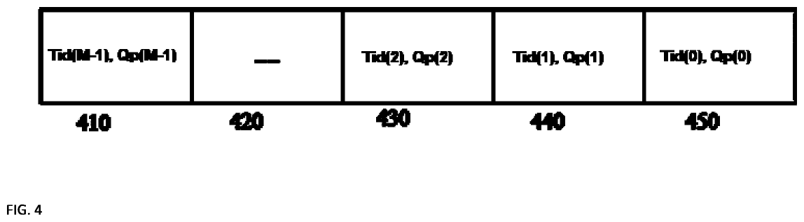

A separate CABAC states table is maintained for each inter picture type of B or P. FIG. 4 shows a CABAC states table of M entries for a given picture type.

As shown in FIG. 4 there are 410 (Tid(M−1), Qp(m−1)); 430 (Tid(2), Qp(2)); 440 (Tid(1), Qp(1)); and 450 (Tid(0), Qp(0)) entries. As can be seen in FIG. 4 entry 420 is left blank.

Each entry is associated with an unique pair of temporal ID (Tid) and quantization parameter (Qp). The M entries are sorted first by temporal ID as:

$$Tid ( m ) \leq Tid ( m + 1 ) , m = 0 , 1 , \qquad ( 1 )$$

and then by quantization parameter as,

$$Qp ( m ) \leq Qp ( m + 1 ) , m = 0 , 1 , \qquad ( 2 )$$

The CABAC states table may be updated after coding of an inter picture, including GDR picture.

Assume an inter picture is just coded. Let Tid and Qp be the temporal ID and quantization parameter of the coded inter picture. If an entry with the same temporal ID and quantization parameter is found in the CABAC states table, CABAC states of this entry is replaced by CABAC states of the coded inter picture. If no entry with the same temporal ID and quantization parameter is found in the CABAC states table, CABAC states in the first entry with Tid(0) and Qp(0) move out and CABAC states of the coded inter picture move in. And all the entries are sorted according to equations (1-2).

In example embodiments of the invention, inter pictures, except GDR pictures, are still allowed to inherit CABAC states from previously coded inter pictures, including GDR pictures. However, GDR pictures shall not inherit CABAC states from previous coded inter pictures, even though GDR pictures are inter pictures. Instead, CABAC initialization shall be invoked for GDR pictures. CABAC states of inter pictures, including GDR pictures, are stored in CABAC states table for future inter pictures.

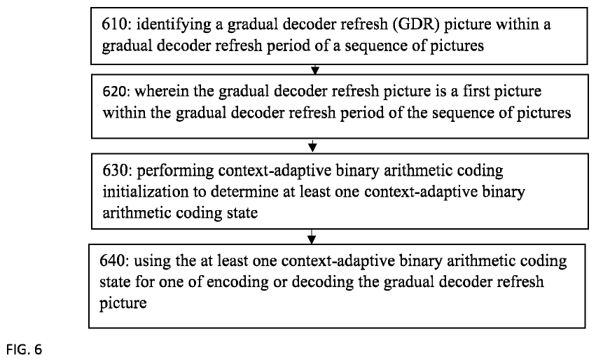

FIG. 6 shows a method in accordance with example embodiments of the invention as disclosed herein which may be performed by an apparatus.

FIG. 6 illustrates operations which may be performed by a network device such as, but not limited to, a network node NN 12 as in FIG. 5 or a network device such as a UE. As shown in step 610 there is identifying a gradual decoder refresh (GDR) picture within a gradual decoder refresh period of a sequence of pictures. As shown in step 620 of FIG. 6 wherein the gradual decoder refresh picture is a first picture within the gradual decoder refresh period of the sequence of pictures. As shown in step 630 of FIG. 6 there is performing context-adaptive binary arithmetic coding initialization to determine at least one context-adaptive binary arithmetic coding state. Then As shown in step 640 of FIG. 6 there is using the at least one context-adaptive binary arithmetic coding state for one of encoding or decoding the gradual decoder refresh picture.

In accordance with the example embodiments as described in the paragraph above, wherein the gradual decoder refresh picture is an inter picture.

In accordance with the example embodiments as described in the paragraphs above, wherein other pictures within a gradual decoder refresh period of the sequence of pictures comprise the gradual decoder refresh (GDR) picture and a plurality of associated recovering pictures.

In accordance with the example embodiments as described in the paragraphs above, wherein a sequence level flag may indicate if inter pictures are allowed to inherit context-adaptive binary arithmetic coding states from previously coded inter pictures, wherein the context-adaptive binary arithmetic coding is coding for data compression.

In accordance with the example embodiments as described in the paragraphs above, wherein based on the sequence level flag indication inter pictures can inherit context-adaptive binary arithmetic coding states from past coded inter pictures, wherein gradual decoder refresh pictures will not inherit context-adaptive binary arithmetic coding states from any past coded inter picture regardless of an indication from the sequence level flag indication.

In accordance with the example embodiments as described in the paragraphs above, wherein the gradual decoder refresh pictures use initialized context-adaptive binary arithmetic coding states regardless of a sequence level flag.

In accordance with the example embodiments as described in the paragraphs above, wherein after one of encoding or decoding the gradual decoder refresh picture, storing or updating at least one context-adaptive binary arithmetic coding state.

In accordance with the example embodiments as described in the paragraphs above, wherein the storing or updating the at least one context-adaptive binary arithmetic coding state is performed after the coding of the gradual decoder refresh picture.

In accordance with the example embodiments as described in the paragraphs above, wherein the gradual decoder refresh picture is of at least one of a type B picture or type P picture.

In accordance with the example embodiments as described in the paragraphs above, wherein a separate context-adaptive binary arithmetic coding states table is maintained for each inter type B picture type or inter type P picture.

In accordance with the example embodiments as described in the paragraphs above, wherein the sequence of pictures comprises at least one of a gradual decoder refresh picture, a recovering picture, or an intra random access point picture.

In accordance with the example embodiments as described in the paragraphs above, wherein each of the at least one entry of the separate context-adaptive binary arithmetic coding states table is associated with a unique pair of a temporal identification and a quantization parameter.

In accordance with the example embodiments as described in the paragraphs above, wherein the separate context-adaptive binary arithmetic coding states table comprises at least one entry.

In accordance with the example embodiments as described in the paragraphs above, wherein a separate context-adaptive binary arithmetic coding states table state is maintained for each picture of the more than one picture.

In accordance with the example embodiments as described in the paragraphs above, wherein each of the at least one state entry is associated with a unique pair of a temporal identification and a quantization parameter.

In accordance with the example embodiments as described in the paragraphs above, wherein the at least one entry is sorted first by the temporal identification and then by the quantization parameter.

In accordance with the example embodiments as described in the paragraphs above, wherein, after an inter picture with a temporal identification and a quantization parameter is coded, if no entry with same temporal identification and same quantization parameter is found in the context-adaptive binary arithmetic coding states table, CABAC states of the coded inter picture then replace a first entry of the context-adaptive binary arithmetic coding states table, wherein entries in the context-adaptive binary arithmetic coding states table are then sorted by temporal identification and quantization parameter.

In accordance with the example embodiments as described in the paragraphs above, wherein if no state entry with a same temporal identification and a quantization parameter is found in the context-adaptive binary arithmetic coding states table, the at least one state entry then replace a first state entry sorted with a temporal identification and quantization parameter of the context-adaptive binary arithmetic coding states table.

In accordance with the example embodiments as described in the paragraphs above, wherein the at least one state entry is sorted in the context-adaptive binary arithmetic coding states table according to equations: Tid(m)≤Tid(m+1), m=0, 1, . . . and then by Qp(m)≤Qp(m+1), m=0, 1, . . . where Tid is a temporal identification and Qp is a quantization parameter and m is an integer representing a number of state entries.

In accordance with the example embodiments as described in the paragraphs above, wherein there is based on the coding performing enhanced compression using an enhanced compression module on the more than one picture picture.

In accordance with the example embodiments as described in the paragraphs above, wherein the coding is one of encoding or decoding the more than one picture, wherein based on encoding starting at the gradual decoder refresh inter picture a gradual decoder refresh inter picture inherits context-adaptive binary arithmetic coding states from previously coded inter pictures.

In accordance with the example embodiments as described in the paragraphs above, wherein based on decoding starting at the intra random access point picture an encoder and decoder are synced and produce a same reconstructed intra random access point picture to be used as reference for the at least one following picture.

A non-transitory computer-readable medium (MEM 10 B and/or MEM 12B of FIG. 5) storing program code (PROG 10C and/or PROG 12C of FIG. 5), the program code executed by at least one processor (DP 10A and/or DP 12A of FIG. 5) to perform the operations as at least described in the paragraphs above.

In accordance with an example embodiment of the invention as described above there is an apparatus comprising: means for identifying (one or more transceivers 10D and/or one or more transceivers 12D; MEM 10B and/or MEM 12B; PROG 10C and/or PROG 12C; and DP 10A and/or DP 12A as in FIG. 5) a gradual decoder refresh picture within a gradual decoder refresh period of a sequence of pictures, wherein the gradual decoder refresh picture is a first picture within the gradual decoder refresh period of the sequence of pictures, and means for performing (one or more transceivers 10D and/or one or more transceivers 12D; MEM 10B and/or MEM 12B; PROG 10C and/or PROG 12C; and DP 10A and/or DP 12A as in FIG. 5) context-adaptive binary arithmetic coding initialization to determine at least one context-adaptive binary arithmetic coding state; and means for using (one or more transceivers 10D and/or one or more transceivers 12D; MEM 10B and/or MEM 12B; PROG 10C and/or PROG 12C; and DP 10A and/or DP 12A as in FIG. 5) the at least one context-adaptive binary arithmetic coding state for one of encoding or decoding the gradual decoder refresh picture.

In the example aspect of the invention according to the paragraph above, wherein at least the means for identifying, performing, and using comprises a non-transitory computer readable medium [MEM 10B and/or MEM 12B as in FIG. 5] encoded with a computer program [PROG 10C and/or PROG 12C] executable by at least one processor [DP 10A and/or DP 12A as in FIG. 5].

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
(i) a combination of analog and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations in accordance with example embodiments of the invention as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory (ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of example embodiments of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1-20. (canceled)

21. An apparatus, comprising:
at least one processor; and
at least one non-transitory memory storing instructions, that when executed by the at least one processor, cause the apparatus at least to:
identify a gradual decoder refresh (GDR) picture within a gradual decoder refresh period of a sequence of pictures,
wherein the gradual decoder refresh picture is a first picture within the gradual decoder refresh period of the sequence of pictures, and
perform context-adaptive binary arithmetic coding initialization to determine at least one context-adaptive binary arithmetic coding state; and
use the at least one context-adaptive binary arithmetic coding state for one of encoding or decoding the gradual decoder refresh picture.

22. The apparatus of claim 21, wherein other pictures within a gradual decoder refresh period of the sequence of pictures comprise the gradual decoder refresh (GDR) picture and a plurality of associated recovering pictures.

23. The apparatus of claim 21, wherein a sequence level flag may indicate if inter pictures are allowed to inherit context-adaptive binary arithmetic coding states from previously coded inter pictures, wherein the context-adaptive binary arithmetic coding is coding for data compression.

24. The apparatus of claim 23, wherein based on the sequence level flag indication inter pictures can inherit context-adaptive binary arithmetic coding states from past coded inter pictures, wherein gradual decoder refresh pictures will not inherit context-adaptive binary arithmetic coding states from any past coded inter picture regardless of an indication from the sequence level flag indication.

25. The apparatus of claim 24, wherein the gradual decoder refresh pictures use initialized context-adaptive binary arithmetic coding states regardless of a sequence level flag.

26. The apparatus of claim 21, wherein the at least one non-transitory memory storing instructions is executed by the at least one processor to cause the apparatus to:
after one of encoding or decoding the gradual decoder refresh picture, store or update at least one context-adaptive binary arithmetic coding state.

27. The apparatus of claim 21, wherein the storing or updating the at least one context-adaptive binary arithmetic coding state is performed after the coding of the gradual decoder refresh picture.

28. The apparatus of claim 21, wherein the gradual decoder refresh picture is of at least one of a type B picture or type P picture.

29. The apparatus of claim 28, wherein a separate context-adaptive binary arithmetic coding states table is maintained for each inter type B picture or inter type P picture.

30. The apparatus of claim 21, wherein the sequence of pictures comprises at least one of a gradual decoder refresh picture, a recovering picture, or an intra random access point picture.

31. The apparatus of claim 29, wherein the separate context-adaptive binary arithmetic coding states table comprises at least one entry.

32. The apparatus of claim 31, wherein each of the at least one entry of the separate context-adaptive binary arithmetic coding states table is associated with a unique pair of a temporal identification and a quantization parameter.

33. The apparatus of claim 32, wherein the at least one entry is sorted first by the temporal identification and then by the quantization parameter.

34. The apparatus of claim 33, wherein, after an inter picture with a temporal identification and a quantization parameter is coded, if no entry with same temporal identification and same quantization parameter is found in the context-adaptive binary arithmetic coding states table, CABAC states of the coded inter picture then replace a first entry of the context-adaptive binary arithmetic coding states table, wherein entries in the context-adaptive binary arithmetic coding states table are then sorted by temporal identification and quantization parameter.

35. The apparatus of claim 33, wherein the at least one entry is sorted in the context-adaptive binary arithmetic coding states table according to equations:
$$Tid ( m ) \leq Tid ( m + 1 ) , m = 0 , 1 , …$$
and then by
$$Qp ( m ) \leq Qp ( m + 1 ) , m = 0 , 1 , …$$
where Tid is a temporal identification and Qp is a quantization parameter and m is an integer representing a number of state entries.

36. The apparatus of claim 21, wherein encoding and decoding are synced to produce a same refreshed area in reconstructed GDR picture to be used as reference for the at least one picture following the gradual decoder refresh picture.

37. A method, comprising:
identifying a gradual decoder refresh picture within a gradual decoder refresh period of a sequence of pictures,
wherein the gradual decoder refresh picture is a first picture within the gradual decoder refresh period of the sequence of pictures, and
performing context-adaptive binary arithmetic coding initialization to determine at least one context-adaptive binary arithmetic coding state; and
using the at least one context-adaptive binary arithmetic coding state for one of encoding or decoding the gradual decoder refresh picture.

38. The method of claim 37, wherein other pictures within the gradual decoder refresh period of the sequence of pictures comprise the gradual decoder refresh (GDR) picture and a plurality of associated recovering pictures.

39. The method of claim 37, wherein a sequence level flag may indicate if inter pictures are allowed to inherit context-adaptive binary arithmetic coding states from previously coded inter pictures, wherein the context-adaptive binary arithmetic coding is coding for data compression.

40. A non-transitory computer readable medium comprising instructions which when executed by an apparatus, cause the apparatus to perform at least the following:
identifying a gradual decoder refresh picture within a gradual decoder refresh period of a sequence of pictures,
wherein the gradual decoder refresh picture is a first picture within the gradual decoder refresh period of the sequence of pictures, and
performing context-adaptive binary arithmetic coding initialization to determine at least one context-adaptive binary arithmetic coding state; and
using the at least one context-adaptive binary arithmetic coding state for one of encoding or decoding the gradual decoder refresh picture.
